(19) United States
(12) Patent Application Publication
(10) Pub. No.: US 2005/0081881 A1
(43) Pub. Date: Apr. 21, 2005

(54) Laser-based cleaning method and system

(76) Inventors: Jarle Skeidsvoll, Lonevag (NO); Torolf Wedberg, Blomsterdalen (NO)

Correspondence Address: NIXON & VANDERHYE, PC, 1100 N GLEBE ROAD, 8TH FLOOR, ARLINGTON, VA, 22201-4714, US

(21) Appl. No.: 10/502,330

(22) PCT Filed: Jan. 24, 2003
(86) PCT No.: PCT/NO03/00024

(30) Foreign Application Priority Data
Jan. 24, 2002 (NO) 20020381

(51) Int. Cl. B08B 3/12

(52) U.S. Cl. 134/1

(57) ABSTRACT

The invention concerns a system for removal of deposits in an area on an optical element in contact with a fluid, defined as optical interface, characterised by including a pulsating laser source directed against the optical interface through the optical element, and where the laser source emits light by a wave length which is absorbed by the deposits.

The present invention regards a method and a system for removal of deposits in a selected area on an optical element in contact with a liquid, defined as an optical interface, and also an optical probe for carrying out measurements in liquids, comprising an optical element having an interface with the liquid. In particular, the invention regards a laser-based system for selective removal of undesirable deposits on the surface of an optical element (optical interface) submerged in a liquid, especially in connection with the measurement of oil in water.

An important condition for satisfactory use of optical sensors is a clean or controlled interface with the medium to be described. In the case of optical measurement in liquids, considerable problems often occur as a result of deposits forming on the optical element(s) in contact with the medium.

Removal of undesirable deposits on optical interface(s) will in most cases be critical to the use of optical sensors. The undesirable deposits may comprise particles, chemical substances and compounds and material films or coatings. Particles may be individual fragments of material in any size from submicron to visible grains. Chemical substances include undesirable chemical elements or chemical compounds. Material films or coatings may be organic, e.g. oil, wax, microorganisms, or inorganic, e.g. salts or oxides.

Generally, any technique used to remove undesirable deposits should do this without altering the physical characteristics of the underlying or adjacent material (optical element).

The present invention makes it possible to selectively remove undesirable deposits without altering the physical characteristics of the optical element underneath or in close proximity to the deposits to be removed.

A number of different techniques have been proposed—and some are being used to remove undesirable deposits on optical interfaces in connection with optical sensors. These include both mechanical (brush and wiper, [high pressure] washing, ultrasound etc.) and chemical techniques (chemical [wet] cleaning) or combinations of these. All these techniques are limited when it comes to their ability to remove undesirable deposits of the composition that may occur in connection with the measurement of oil in water. Previously proposed techniques will result in a consumption of large amounts of (expensive) material (cleaning solution) and a high energy consumption, and are only of limited use under demanding physical conditions (high temperature and pressure etc.). Several of the techniques are not very robust and/or require extensive maintenance).

U.S. Pat. No. 5,958,268 describes the removal of undesirable deposits by use of polarised radiation, detailing a method and a system for removal of particles from a substrate by means of laser exposure and a flow of inert gas to carry off the removed material. In the patent, parameters are established for laser-based cleaning of substrate under dry conditions. The patent suggests that in the case of removal of materials located on a transparent substrate, the efficiency may be enhanced by first sending the laser beam through the substrate prior to it striking the material. It is also suggested that this method significantly reduces the levels of energy and power flux that are required to achieve satisfactory cleaning. The solution described is adapted especially for removal of various types of undesirable deposits in a dry environment (not submerged in liquid). The requirement for a flow of inert gas across the substrate to carry off the removed materials makes the invention unsuited for use in connection with an optical measuring probe submerged in liquid.

International patent application PCT/US97/05007 (WO 97/35685) describes cleaning of an optical element set in a combustion chamber, by means of a pulsed infrared laser (1064 nm). This publication describes a solution that is especially suited for removal of soot from combustion chambers, and is dependent among other things on the optical element (window) being heated to 350° C. before the deposits are removed. This solution will not be suited for use on optical elements submerged in a liquid. Furthermore, the absorption in deposits to be removed from optical elements in the case of optical measurement in oil-in-water is low in the infrared wavelength range. Compensating for the low absorption of infrared light in deposits will require a very high laser output, and is in practice an unsuitable solution.

A similar set-up is described in the article Min She et al.: “Liquid-assisted pulsed laser cleaning using infrared and ultraviolet radiation”, Journal of Applied Physics, vol. 86, no. 11, 1. Dec. 1999. Here, use is also made of a thin liquid film in order to remove particles from a surface. In this case, the surface is not an optical element, and the laser beam comes in from the same side of the surface as that on which the particles are located. Therefore, this solution is not suitable either for use in optical elements submerged in a liquid, as the laser beam would then have to propagate through a liquid of potentially varying absorption. Furthermore, the solution in the article is based on heating of the actual surface, which in most cases is not suitable for optical elements submerged in a liquid.

Consequently it is an object of the present invention to provide a system for cleaning optical elements submerged in a liquid and an optical measuring probe comprising such a system, characterised according to the independent claims.

In particular, the invention regards a system that cleans the interface of an optical measuring probe submerged in a liquid, where the formation of deposits on the interface reduces the quality of the measurement data.

Deposits that may occur in connection with measurements of oil in water, organic deposits such as oil, wax and biofilm, are much more easily removed by pulsed ultraviolet laser light than by visible or possibly NIR/IR light (1064 nm as referred to in WO 97/35685). This is due among other things to the high absorption of the deposits in the wavelength range in question. This absorption decreases with increasing wavelength, and at 532 nm (visible light) the effect is considerably reduced relative to ultraviolet light. As mentioned above, almost all reduction in cleaning efficiency caused by a maladjusted wavelength can be compensated by a significant increase in pulse energy per unit area, however this causes the system to lose its industrial applicability.

In the present invention deposits on an optical interface are exposed to photons at a high density (space and time; energy and effect), sufficient to remove the undesirable material but without altering the physical characteristics of the underlying and adjacent material. One condition for removing undesirable material is that the bonds between this and adjacent material (other material of the same composition, optical element or a third material) must be broken. Each bond is broken by introducing an amount of energy greater than or equal to the energy required to form it. The establishment of a threshold value for damage (effect and energy flux) to the optical element in question presupposes experimental trials.

The photon source used for cleaning may be any light source, as long as it emits photons with a sufficiently high energy level. Examples of such photon sources are pulsating or continuously emitting lasers. If the nature of the undesirable deposit calls for high energy levels, a pulsed ultraviolet emitting laser is preferable.

Fundamental parameters for cleaning are the wavelength of the photon source, power flux and for pulsating photon sources; the pulse duration and the number of pulses. A pulse width in the pico- to nanosecond range is required to contribute to heating, expansion and direct removal of the undesirable deposits. A liquid near the undesirable deposits may through intense local evaporation and pressure increase enhance the cleaning effect while helping to reduce unwanted thermal changes in the optical element. A flowing liquid will also carry loosened material off from the optical element, thus contributing to a further improvement of the cleaning effect.

With high energy (10⁶-10⁸ W/cm²) laser pulses (1-100 ns) the cleaning effect is assumed to result primarily from photomechanical processes in the material absorbing the laser energy, i.e. formation of plasma with subsequent rapid plasma expansion (shock wave). The processes result in mechanical degradation of the exposed material. The thermal effects are believed to be insignificant in the case of such short laser pulses. A number of factors can affect the effect of laser cleaning. The most important are the chemical (intra- and intermolecular forces), optical (absorption) and mechanical (porosity, thickness etc.) properties of the deposits. Chemical and physical properties of deposits on optical elements may vary significantly, e.g. between a 10 μm organic film and 700 μm mineral deposits. A universal (ideal) laser-based cleaning system for optical sensors must be capable of removing all relevant undesirable deposits on an optical interface.

In the following, the invention will be described with reference to the accompanying drawings, which illustrate the invention by way of example.

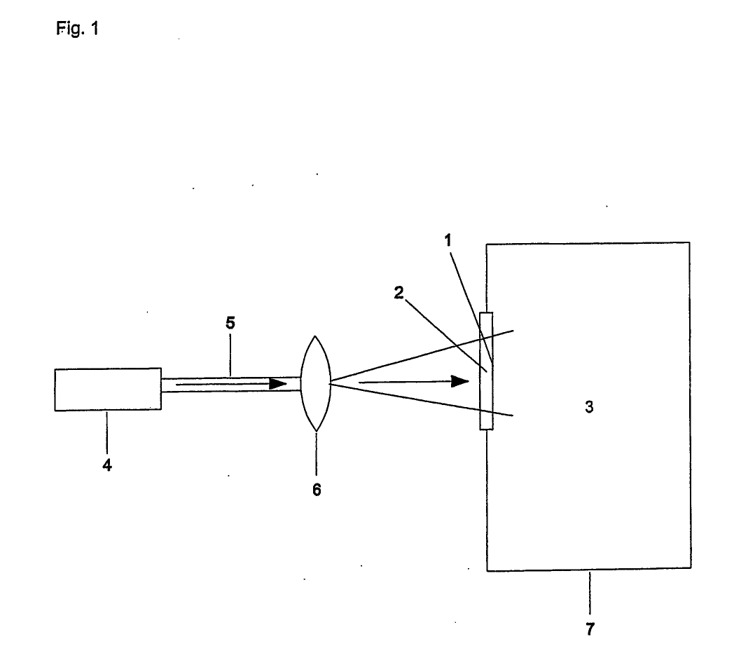

FIG. 1 schematically illustrates the optical system according to the invention; and

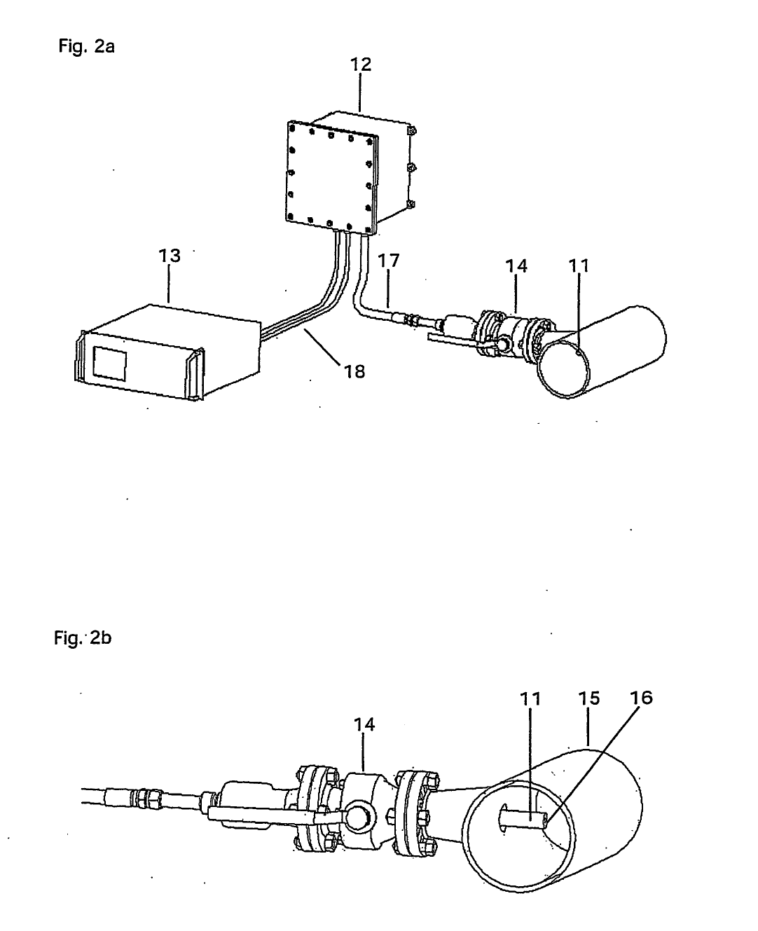

FIG. 2 illustrates an example of a sensor comprising the invention.

FIG. 1 schematically illustrates the principle of the invention, comprising an optical element 2 having an interface 1 with a liquid 3. In the figure, the optical element 2 is represented by a glass plate, e.g. a window in a pipe 7, but depending on the application, the optical element 2 may also constitute a lens, optical fibre or similar.

A laser source 4 directs a beam 5 at the window 2, which beam in this case is distributed across the window 2 by a lens 6 in order to remove deposits across a predetermined area.

Removal of deposits presupposes the use of laser technology to achieve the desired result. Preferably, the laser source emits in the spectral range from ultraviolet light to visible light, preferably at 355 nm and 532 nm, which corresponds to a frequency-tripled or frequency-doubled Nd:YAG laser.

Preferably, the laser source generates very short pulses—with duration (pulse width) in the pico- to microsecond range and, based on experimental data, preferably between 0.1 and 12 nanoseconds (data).

The laser source 4, the lens 6 or other parts of the system provide a distribution of the energy across the surface corresponding to a pulse energy per unit area (power flux, J/cm⁻²) in the order of 10 mT/cm² and higher.

Experiments show a cleaning effect with an Nd:YAG laser source as described above on a series of different materials with power flux values from 100-600 mJ/cm² (data).

The optical system 6, 2 is the link between the photon source and a contaminating liquid. Contaminating indicates that the liquid contains components (chemical substances and compounds, microorganisms, particles etc.) that reduce the transparency of the optical surface. The construction of the optical system may vary significantly depending on how and in what connection the cleaning technique is to be used. In its simplest form, the system may be a single window 2 towards the liquid, which presupposes that the output of the laser source and the distance from the window define the energy distribution across the optical interface, or it may be a complex set of optical elements (lenses, prisms, mirrors, optical fibres etc.) that direct the laser light towards the interface between the optical system and the contaminating liquid.

Conveyance of laser light via optical fibres increases the system flexibility such that the laser source can be positioned remotely from the optical interface. The optical system may also be constructed so as to combine the cleaning function with other functions, e.g. signal transmission.

FIG. 2 shows an example of a sensor comprising the invention, consisting of three main parts: Optical measuring probe 11, field electronics module 12 and control unit 13. The optical measuring probe mounted on extracting tool 14 is installed directly in the pipe 15 (in-line) with the optical interface 16 (sapphire window) positioned in the area between the inner pipe wall and the centre of the pipe. The excitation source and the laser for cleaning of the optical interface are placed in field electronics module 12. Light from the light sources is connected into optical fibres for transmission via fibre optic cable 17 to optical measuring probe 11. The optical signal (fluorescence) is transmitted from the optical measuring probe via optical fibres in fibre cable 17 to a photosensor in field electronics module 12, which in addition to the photosensor also contains electronics for signal processing and operation and control of the components which it includes. The measurement signal from the photosensor to the parent control unit, electronic signals for monitoring and control of field module 12 and operating voltage are transmitted through electrical cables 18 between the units 12 and 13.

When producing and processing crude oil a number of measurements and analyses are carried out in order to check and monitor the contents of relevant liquids. An example of such measurements is the measurement of oil in water. Presently, a number of techniques are used for this, including systems based on light scatter, ultraviolet fluorescence, ultraviolet absorption, infrared absorption, ultrasound, photoacoustics etc. Several of these techniques are based on the optical properties of the medium being tested or monitored. Devices for carrying out such measurements may be described as optical sensors.

Especially when performing measurements in oil-in-water mixtures, deposits are formed on the optical interface(s), which may reduce the quality of the measurement data The present invention has been developed to clean an optical element submerged in liquid. The liquid medium may be water or other liquids, it may be flowing or still, and it may be open (sea) or completely or partly closed in (pipe or tank). Specifically, it regards cleaning of an optical measuring probe in connection with oil-in-water monitoring. The optical measuring probe is to be installed directly in a pipe (in-line) for so-called produced water and therefore requires an efficient cleaning mechanism so as to prevent components of the medium from reducing the quality of the measurement data

1. A method for removing deposits from a selected area of an optical element in contact with a liquid, defined as an optical interface,
wherein use is made of a pulsed laser source directed at the optical interface through the optical element, and where the laser source emits light at a wavelength that is absorbed by the deposits.

2. A method according to claim 1, wherein the laser source emits light pulses within the wavelength range from ultraviolet light to visible light.

3. A method according to claim 2, wherein the laser source emits light at 355 nm and/or 532 nm.

4. A method according to claim 1, wherein the pulse energy per unit area in the selected area exceeds 10 mJ/cm², preferably in the range 100-600 mJ/cm².

5. A method according to claim 1, wherein the pulse duration is in the order of 10⁻¹²s to 10⁻⁶s, preferably 1-10·10⁻⁹s.

6. A method according to claim 1, wherein it furthermore comprises the use of an optical system for conducting and distributing the emitted light from the laser source across the selected area.

7. A method according to claim 1, wherein it furthermore comprises the use of optical fibres and/or a light pipe for conducting and distributing the emitted light from the laser source across the selected area.

8. A method according to claim 1, wherein the deposits are organic and/or inorganic, and the wavelength, energy per unit area and pulse duration are tailored to the deposits in question.

9. An optical probe for carrying out measurements in liquids, comprising an optical element having an interface with the liquid, wherein the probe comprises a cleaning system for removal of deposits in an area of the interface, the cleaning system comprising a pulsed laser source directed at the interface through the optical element, where the laser source emits light at a wavelength that is absorbed by the deposits.

10. A probe according to claim 9, wherein the laser source is connected to a light pipe that conducts the light into the probe.

11. A system for implementing the method according to claim 1,
wherein it comprises a pulsed laser source designed to direct light at the optical interfaces through the optical element towards the area in question, and where the laser source is designed to emit light at a wavelength that is absorbed by the deposits.

12. A system according to claim 11, wherein it furthermore comprises an optical system designed to conduct and distribute the emitted light from the laser source across the selected area.

13. A system according to claim 11, wherein it furthermore comprises optical fibre(s) and/or a light pipe for conducting and distributing the emitted light from the laser source across the area in question.
